(19) United States
(12) Patent Application Publication
(10) Pub. No.: US 2012/0160842 A1
(43) Pub. Date: Jun. 28, 2012

(54) Microwave Bowl

(76) Inventor: Mario John Chaves Barker, New Territories (CN)

(21) Appl. No.: 13/314,476

(22) Filed: Dec. 8, 2011

(30) Foreign Application Priority Data
Dec. 8, 2010 (AU) 2010905407

(51) Int. Cl. H05B 6/80

(52) U.S. Cl. 219/726

(57) ABSTRACT

A microwave bowl for use in the heating compartment of a microwave oven has a bowl body which has a first coefficient of friction. A support portion is fixed to the bowl body and engages the turntable. The support portion is adapted to at least partially support the bowl body on the turntable. The support portion has a second coefficient of friction greater than the first coefficient of the bowl body. The bowl also includes a lid assembly which has arms extended to engage the walls of the oven when the turntable rotates. The lid is provided with a stirring mechanism. The support portions act as a clutch to permit relative movement between the turntable and the bowl body.

### TECHNICAL FIELD

The present invention relates to bowls to be used in a microwave oven.

### BACKGROUND OF THE INVENTION

When heating substances that are at least partly liquid in a microwave bowl a number of problems exist.

If the bowl, containing the substance rotates with the turntable of the microwave oven, the substance is not uniformly heated. More particularly the portion of the substance located adjacent the bowl body heats more quickly than portions of the substance adjacent the centre of the bowl. This often leads to portions of the substance becoming overheated and possibly even burnt.

Attempts have been made to overcome the above problem by providing bowls with a stirring mechanism. The bowl is mounted on the turntable, with the bowl having a means of engaging the internal surfaces of the oven to cause a stirring mechanism in the bowl to stir the contents of the bowl. However these devices have encountered a number of problems including the motor that drives the turntable having insufficient power. This is often encountered where the substance in the bowl is very viscous or has non liquid portions. This results in the turntable becoming stalled.

A still further problem is incorrect placement of the bowl at the centre of the turntable. This can often result in stalling of the turntable stalling and/or inconsistent heating of the substance.

### SUMMARY

There is disclosed herein a microwave bowl including:

a hollow bowl body to receive a substance to be heated via microwave, with the bowl body having a coefficient of friction; and

a support portion fixed to the bowl body and to engage the turntable so that the support portion is adapted to at least partly support the bowl body on the turntable, and wherein the support portion has a coefficient of friction greater than the bowl body.

Preferably, the support portion is resiliently deformable.

Preferably, the bowl body has a bottom wall to which the support portion is attached. The bottom wall has ridges to engage the turntable in conjunction with the support portions.

Preferably, the support portion includes a plurality of resilient pads fixed to the bottom wall to engage the turntable to at least partly support the bowl body.

Preferably, the support portion is formed of synthetic or natural rubber or a silicon material.

Preferably, the microwave bowl includes a lid assembly. The lid assembly has at least one arm to extend beyond the bowl body to engage the microwave oven to urge the lid assembly to rotate relative to the bowl body.

Preferably, the microwave bowl includes a stirring member, fixed to the lid assembly, and projecting inwardly of the bowl body to engage the substance to stir the substance upon relative rotation between the lid assembly and the bowl body.

### BRIEF DESCRIPTION OF THE DRAWINGS

Preferred forms of the present invention will now be described by way of example with reference to the accompanying drawings wherein:

FIG. 1 is a schematic isometric view of a microwave bowl;

FIG. 2 is a schematic sectioned side elevation of the bowl of FIG. 1;

FIG. 3 is a schematic bottom isometric view of the bowl of FIG. 1;

FIG. 4 is a schematic sectioned side elevation of a portion of the bowl of FIG. 1;

FIG. 5 is a further sectioned side elevation of the portion as shown in FIG. 4;

FIG. 6 is the schematic top plan view of portion of the bowl of FIG. 1;

FIG. 7 is a schematic sectioned side elevation of the bowl of FIG. 1;

FIG. 8 is a further schematic sectioned side elevation of the bowl of FIG. 1;

FIG. 9 is a schematic isometric view of the bowl of FIG. 1 contained in the heating compartment of a microwave oven;

FIG. 10 (A-E) is a series of schematic top plan views of the bowl as shown in FIGS. 9; and

FIG. 11 is a bottom isometric view of another embodiment of a microwave bowl.

### DETAILED DESCRIPTION OF THE PREFERRED EMBODIMENTS

In the accompanying drawings there is schematically depicted a microwave bowl 10 to be contained in the heating compartment 11 of a microwave oven. The compartment 11 has three walls 12 and a front door (not illustrated).

The bowl 10 includes a hollow bowl body 13 that is generally rigid. For example the body 13 may be formed of relatively stiff plastics material or glass. The body 13 would have a coefficient of friction.

The bowl 10 has a top rim 14 upon which there rests a lid assembly 15. The lid assembly 15 includes a pair of handles 16 that would also act as catches to retain the lid 15 engaged to the rim 14. This is to inhibit lifting of the lid assembly 15 from the rim 14. By pivoting movement of the handles 16, the handles 16 can be moved to a position permitting removal of the lid assembly 15.

The handles 16 merely secure the lid assembly 15 to the bowl body so that the lid assembly 15 can rotate about a generally upright axis relative to the bowl body 13.

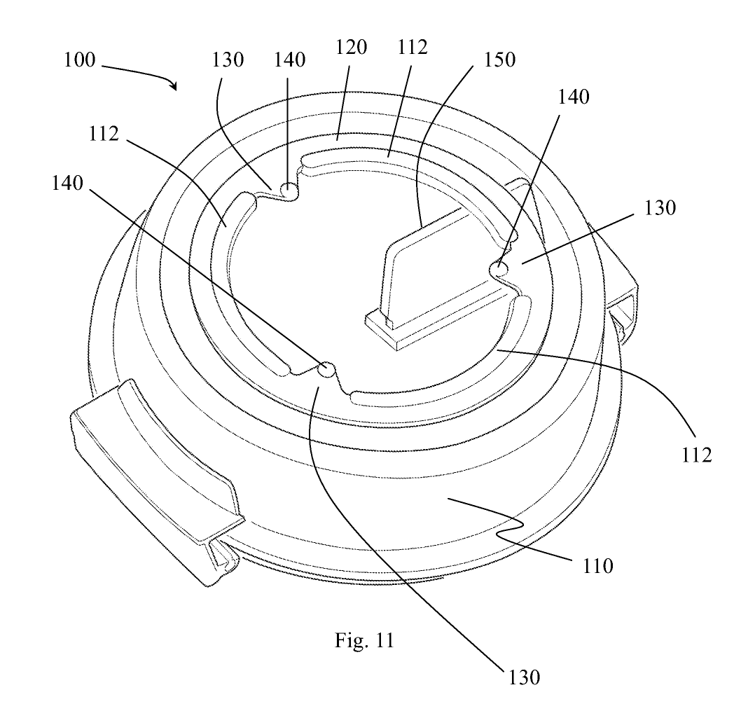

The lid assembly 15 also has three rails 17 that slidably support a pair of arms 18 that are linearly moveable between a retracted position, essentially not projecting beyond the body 13, and an extended position (as shown in FIG. 10) so as to engage the surfaces of at least one of the walls 12 or abovementioned door.

Preferably, the arms 18 would engage the rails 17 so as to resist relative movement therebetween so that when the arms 18 engage the walls 12, the arms 18 do not move to a retracted position. The arms 18 engage the walls 12 to cause relative rotation between the lid assembly 15 and bowl body 13.

The body 13 includes a side wall or walls 19 that project upwardly from a bottom wall 20.

The bottom wall 20 has a plurality of ridges 21 that in this embodiment are generally circular in configuration. Operatively associated with the ridges 21 are further circular ridges 22 between which there is provided an annular slot 23.

Mounted in the slots 23 are support portions 24 that include an annular lip 25 fixed in the associated slot 23, and a diaphragm portion 26. The diaphragm portion 26 is provided at its center with a raised projection 27. Preferably, each support portion 24 is formed of resilient material that has a coefficient of friction greater than that of the body 13 (bottom wall 20).

As best seen in FIGS. 4 and 5, when the bowl 10 is at a raised position, the support portions 24 project downwardly beyond the lower extremities of the ridges 21. However when the bowl 10 rests on the turntable 28, the support portions 24 are resiliently deformed so as to be moved to a retracted position (as shown in FIG. 5) so as not to project downwardly beyond the lower extremities of the ridges 21. However the projection 27 is urged into contact with the upper surface 29 of the turntable 28.

Preferably, each of the support portions 24 is formed of natural or synthetic rubber, or a silicon material. The material forming the support portions 24 is selected so that frictional engagement of each support portion 24 with the surface 29 urges the bowl 10 to rotate with the turntable 28.

In the above described preferred embodiment, there are three support portions 24, however it should be appreciated that any number of support portions 24 may be used, including a single support portion.

In operation of the above described bowl 10, the body 13 is at least partly supported by the support portions 24. However the ridges 21 do engage the surface 29 so as to also at least partly support the body 13.

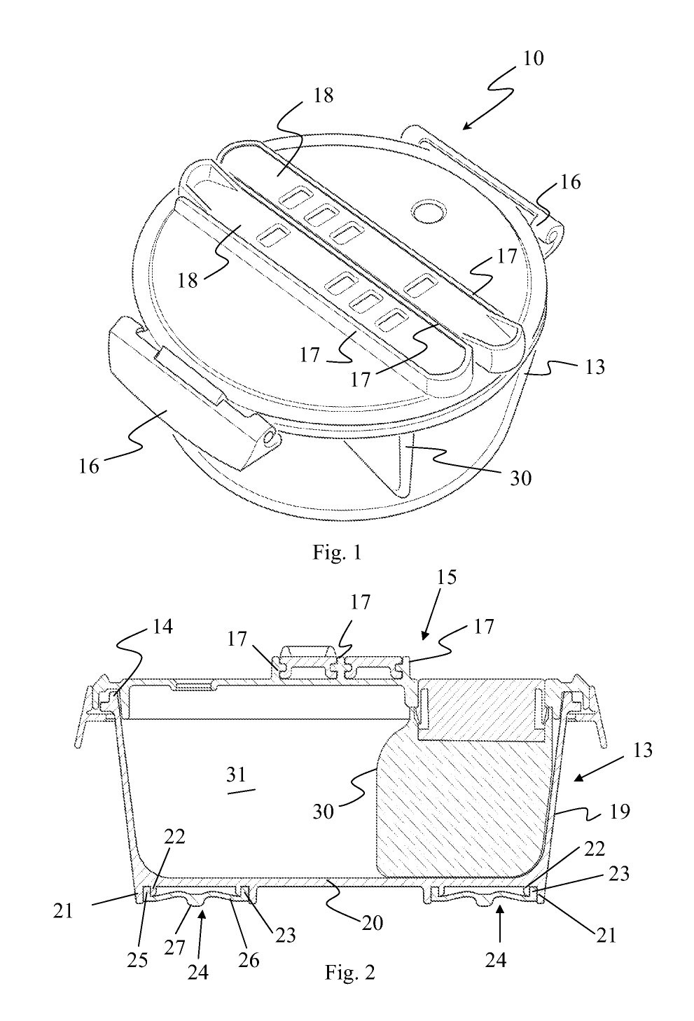

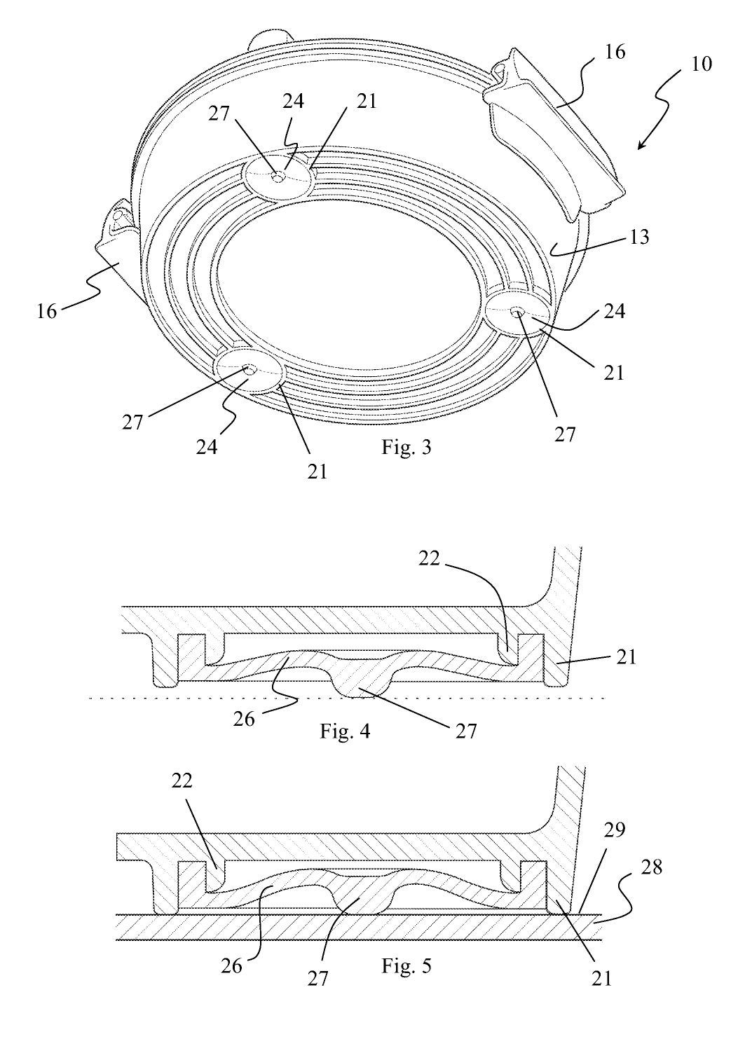

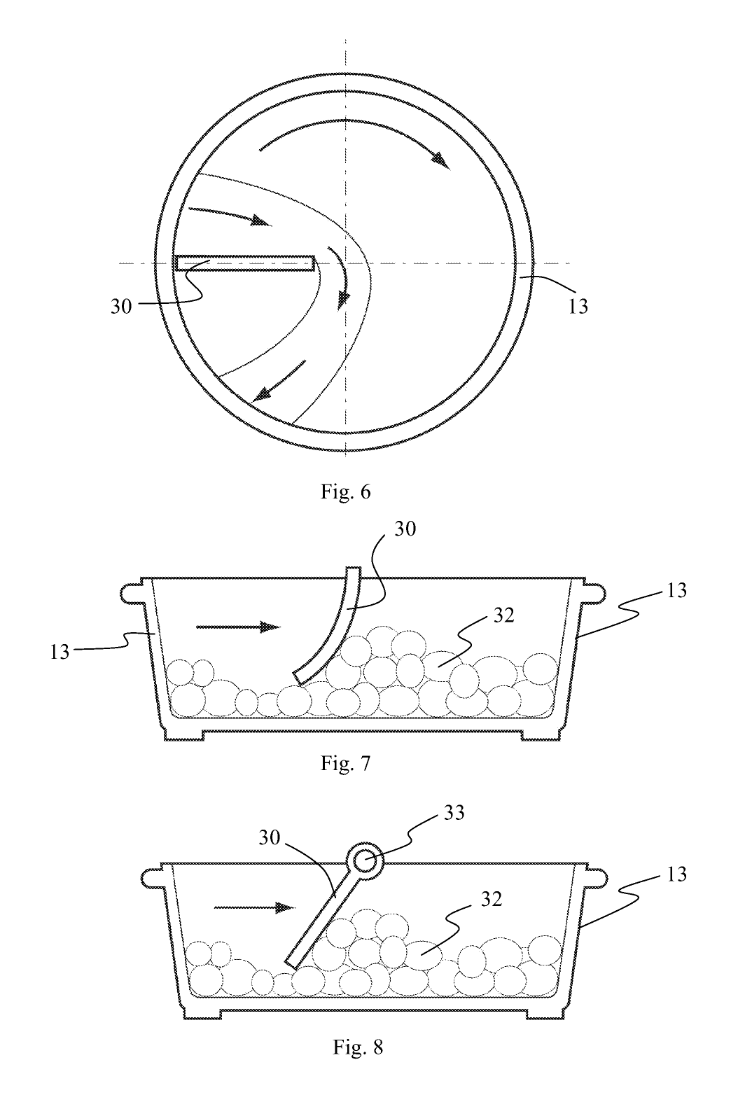

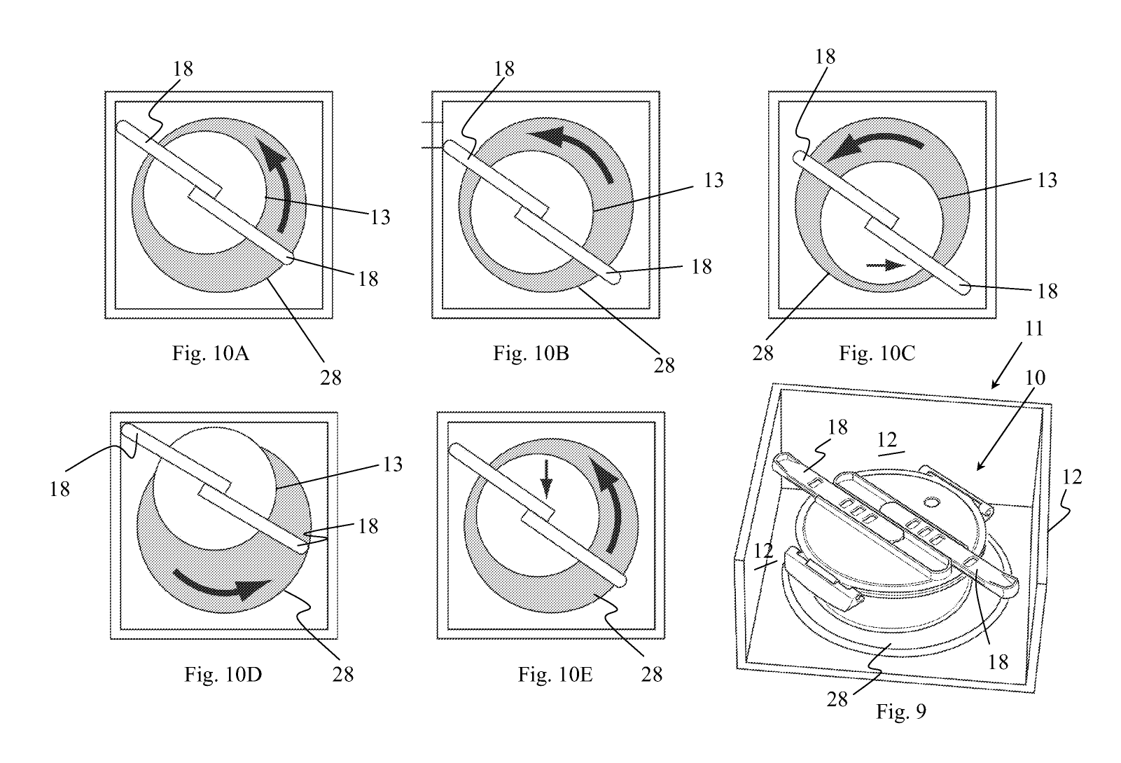

The bowl 10 is placed in the microwave oven so as to rest upon the turntable 28. The arms 18 are extended to a position at which they will engage the walls 12. Thereafter the microwave oven may be activated. If the bowl 10 is correctly positioned, the turntable 28 will rotate, taking with it the bowl body 13. To stir the contents within the body 13, the lid 15 is provided with a stirring mechanism, such as the paddle 30 shown in FIG. 2. The paddle 30 projects downwardly into the interior 31 of the body 13, so that upon rotation of the body 13 with the turntable 28, the paddle 30 moves through the substance within the body 13 as the lid assembly 15 engages the walls 12.

If the motor of the microwave oven has insufficient power to turn the body 13, the substance (being partly liquid) will heat with the result that its viscosity will be lowered so that ultimately the body 13 would be allowed to rotate as the substance will be moved by the paddle 30.

In the embodiment of FIG. 8, the paddle 30 is configured so as to be arcuate so that at least part of the substance 32 can move beneath the paddle 30. In another embodiment, the paddle 30 may be formed of flexible material to enable it to deflect to the position shown in FIG. 8. As a still further embodiment, the paddle 30 may be pivotally mounted on a shaft or axle 33 but urged to cause stirring of the substance 32.

The above described preferred embodiment has a number of advantages including the support portions 24 acting as a clutch to permit relative movement between the turntable 28 and body 13 while still urging the body 13 to rotate relative to the turntable 28, when the substance contained in the body 13 is of a viscosity permitting the paddle 30 to move through the substance.

For the paddle 30, to stir the contents of the body 13, the body 13 rotates relative to the lid assembly 15 about a generally upright axis. The axis is generally central of the bowl 10 and lid assembly 15. Preferably, the paddle 30 is resiliently deformable so as to resiliently deform as shown in FIG. 7. When solid portions are engaged by the paddle 30, the paddle 30 deflects to allow the solid portions to pass thereby. Still further, if the substance 32 is initially too viscous, then the paddle 30 will deflect allowing rotation of the lid assembly 15 relative to the body 13. As the substance 32 is heated, the viscosity thereof will decrease allowing the paddle 30 to assume a more generally upright position.

A further advantage is permitting the body 13 to slip relative to the turntable 28 to provide for centering of the bowl 10 in the chamber 11. This operation is best seen in FIG. 10. For example, if the bowl is incorrectly mounted as shown in FIG. 10 (A), the bowl body 13 would be urged to center itself on the turntable 28.

With reference to FIG. 11, another embodiment of a microwave bowl is generally designated by the numeral 100. A support portion 120 is formed of natural or synthetic rubber or a silicone material and is a one-piece member. The bowl body 110 engages and is supported on the support portion 120. The support portion 120 of the bowl is configured as a one-piece foot which has an outer ring-like shape with three equi-angularly spaced flexible tabs 130 which protrude inwardly. The tabs 130 each have an integral downwardly extruded pad 140. The underside of the bowl body has three arcuate ridges 112 which engage inner arcuate edge sections of the ring-like portion of the foot. Each of the pads 140 moves up and down, reducing the pressure of the pad onto the turntable 28. This allows the pads 140 to slip when too much pressure is applied to the paddle 150.

It should be appreciated that the support portion may be configured as a plurality of feet and assume numerous forms. For example, the bowl may be substantially rectangular rather than circular, and accordingly, the support portion may be configured for a rectangular shaped bowl. In addition, the support portion need not have a ring-like shape or three equi-angular spaced tabs or be restricted to three tabs. The pads need not be downwardly extruded. In addition, the underside of the bowl may have at least one ridge and is not restricted to three ridges and the ridges need not be arcuate.

1. A microwave bowl comprising:
a hollow bowl body configured to receive a substance to be heated by a microwave, the bowl body having a first coefficient of friction; and
a support portion fixed to the bowl body and adapted to engage a turntable so that the support portion is adapted to at least partly support the bowl body on the turntable, said support portion having a second coefficient of friction greater than the first coefficient of friction.

2. The microwave bowl of claim 1 wherein the support portion is resiliently deformable.

3. The microwave bowl of claim 1 wherein the bowl body has a bottom wall to which the support portion is attached, said bottom wall having a plurality of ridges configured to engage the turntable in conjunction with the support portion

4. The microwave bowl of claim 3 wherein said support portion includes a plurality of resilient pads fixed to the bottom wall to engage the turntable to at least partially support the bowl body.

5. The microwave bowl of claim 3 wherein the ridges are circular.

6. The microwave bowl of claim 1 wherein said support portion is formed of a material selected from the group consisting of synthetic rubber, natural rubber and a silicone material.

7. The microwave bowl of claim 1 and further including a lid assembly, the lid assembly having at least one arm extending beyond the bowl body.

8. The microwave bowl of claim 7 further comprising a stirring member fixed to the lid assembly and projecting inwardly of the bowl body to engage a substance received in said bowl body to stir the substance upon relative rotation between the lid assembly and the bowl body.

9. The microwave bowl of claim 7 wherein the lid assembly has rails and there are two arms which engage the rails and resist relative movement with the rails.

10. The microwave bowl of claim 1 wherein the support portion further comprises a diaphragm portion with a raised projection.

11. The microwave bowl of claim 8 wherein the stirring member is a paddle.

12. In combination, a turntable and a microwave bowl comprising:
a turntable for a microwave oven;
a microwave bowl comprising:
a hollow bowl body configured to receive a substance to be heated via microwave, said bowl body having a first coefficient of friction; and
a support portion fixed to the bowl body and engaging said turntable so that the support portion at least partially supports the bowl body on the turntable and wherein said support portion has a coefficient of second friction greater than the first coefficient of friction.

13. The combination of claim 12 wherein said support portion is resiliently deformable.

14. The combination of claim 13 wherein said bowl body has a bottom wall to which the support portion is attached, said bottom wall having a plurality of ridges engaging the turntable in conjunction with the support portion.

15. The combination of claim 14 wherein said support portion includes a plurality of resilient pads fixed to the bottom wall engaging the turntable to at least partially support the bowl body.

16. The combination of claim 12 wherein said microwave bowl further includes a lid assembly, said lid assembly having two arms which each extends beyond the bowl body.

17. The combination of claim 16 wherein said microwave bowl includes a stirring member fixed to the lid assembly and projecting inwardly in the body to engage a substance to stir the substance upon relative rotation between the lid assembly and the bowl body.

18. A microwave oven and microwave bowl comprising:
a microwave oven including side walls with a bottom supporting a turntable;
a microwave bowl supported on the turntable and comprising:
a hollow bowl body to receive a substance to be heated via microwave oven, said bowl body having a first coefficient of friction; and
a support portion fixed to the bowl body engaged on the turntable so that the support portion is adapted to at least partly support the bowl body on the turntable and said support portion having a second coefficient of friction greater than the bowl body.

19. The microwave oven and bowl combination of claim 18 wherein said microwave bowl further includes a lid assembly, said lid assembly having at least one arm that extends beyond the bowl body to engage a wall of the microwave oven to urge the lid assembly to rotate relative to the bowl body.

20. The microwave oven and microwave bowl assembly of claim 18 wherein said microwave bowl further includes a stirring member fixed to the lid assembly and projecting inwardly of the bowl body to engage a substance received in said bowl body to stir the substance upon relative rotation between the lid assembly the bowl body.
